(19) United States
(12) Patent Application Publication
(10) Pub. No.: US 2013/0138287 A1
(43) Pub. Date: May 30, 2013

(54) VEHICLE, IN PARTICULAR A HYBRID VEHICLE, AND METHOD FOR CONTROLLING AN AUTOMATED TRANSMISSION UNIT OF A VEHICLE

(71) Applicants: Christian Brenneke, Garbsen (DE); Stefan Brinkmann, Wunstorf (DE); Konrad Feyerabend, Hannover (DE)

(72) Inventors: Christian Brenneke, Garbsen (DE); Stefan Brinkmann, Wunstorf (DE); Konrad Feyerabend, Hannover (DE)

(73) Assignee: WABCO GmbH, Hannover (DE)

(21) Appl. No.: 13/814,879

(22) PCT Filed: May 12, 2011
(86) PCT No.: PCT/EP11/02348

§ 371 Date: Feb. 7, 2013

(30) Foreign Application Priority Data
Aug. 11, 2010 (DE) 10 2010 034 003.

(51) Int. Cl. B60W 20/00; B60W 10/30; B60W 10/11

(52) U.S. Cl. CPC B60W 20/00; B60W 10/11; B60W 10/30; B60W 2600/00; Y10S 903/93
USPC 701/22; 701/53; 180/65.265; 903/930

(57) ABSTRACT

The invention relates to a vehicle (1), which has: an internal combustion engine (6), an output shaft (3), a transmission unit (13; 8, 12) provided between the internal combustion engine (6) and the output shaft (3) for setting different gear ratios and/or decoupling the internal combustion engine (6) from the output shaft (3), and a compressed-air system (5) having a compressor (16) arranged on an engine shaft (7) of the internal combustion engine (6) and a compressed-air control unit (18). According to the invention, the compressed-air control unit (18) outputs a requirement signal (S4) for a transmission setting.

The present invention generally relates to a vehicle, in particular a hybrid vehicle, and a method for controlling an automatic transmission unit of a vehicle.

Compressed air systems in vehicles are used inter alia for pneumatic brakes and level control systems (by way of air bellows), if applicable, also for additional consumers. The compressed air is conveyed by way of a compressor that is arranged, particularly in the case of utility vehicles, directly on the engine shaft of the combustion engine and, if applicable, the compressor can also be coupled by way of a compressor-coupling.

The compressed air requirement is generally determined by way of a compressed-air control device of the compressed air system, wherein this compressed-air control device adjusts the compressed air supply from the compressor by controlling a compressor-coupling or by controlling an idling mode of the compressor and in addition also controlling valves of the compressed air system in order to set different operating modes of the compressed air system.

By virtue of the fact that the compressor is arranged directly on the engine shaft and not, for example, on an output shaft that is arranged downstream of the transmission unit, the compressor can consequently be operated, for example, even with an idling engine when the transmission unit is decoupled. However, the direct coupling means that the delivery rate of the compressor is also dependent upon the engine rotational speed, which can be too low, possibly when the engine is idling and the air requirement is increased.

In this case, it is known, for example, from DE 10 2007 032 963 A1, during coasting phases, in which the effective torque delivered by the engine and/or the engine torque is less than the drive torque that is available by virtue of the kinetic energy of the vehicle when the transmission unit is coupled in, to utilize this kinetic energy of the vehicle to operate the compressor. Consequently, the kinetic energy of the vehicle can be utilized in order thereby to deliver compressed air and accordingly to reduce the fuel consumption of the vehicle.

However, coasting phases when a high gear is selected and the engine rotational speed is low are possibly too short in order merely thereby to sufficiently fill the compressed air reservoir in the compressed air system. In addition, in the case of some vehicles during coasting phases the combustion engine and consequently the compressor are separated from the drive train automatically by actuating the coupling, in order during a coasting mode to be able to utilize the kinetic energy completely in order for the vehicle to continue coasting without engine braking.

In addition, it is possible to increase the engine rotational speed during the idling phase in order to increase the delivery rate of the compressor; however, a measure of this type is not available when the vehicle is traveling.

A return-feed of used air is possibly too slow in critical phases, it is therefore necessary to store a larger quantity of air in the air reservoirs of the compressed air system, which results in correspondingly larger embodiments.

Hybrid vehicles comprise a hybrid unit, in which one or a plurality of electro-motors is provided in addition to the combustion engine. In particular, in the case of parallel-hybrid vehicles the drive can be provided as desired by way of the combustion engine or by way of the electro-motor or by way of a combination of the two, wherein it is possible during coasting phases to implement a recuperating mode of recovering energy by means of the electro-motor and/or an additional generator. In order to set the recuperating mode and a purely electric drive, the combustion engine can, for example, be decoupled, so that it is no longer running under unnecessary loading. A disadvantage of this is, however, that a compressor that is arranged on the engine shaft can no longer be driven simultaneously.

It is an object of the present invention to render possible an effective operation of the air processing system, in particular also in different travel states of the vehicle.

This object is achievable by virtue of a vehicle as claimed in independent claim 1 and a method as claimed in independent claim 11. The subordinate claims describe preferred embodiments.

In accordance with embodiments of the present invention, one or a plurality of requirement signals are consequently transmitted by the control device of the air processing system and/or of the compressed air system, which signals indicate an increased requirement for compressed air.

In this case, continuous requirement signals can be transmitted, which if applicable indicate that compressed air is not required; in addition, it is also possible that a corresponding requirement signal is transmitted only when compressed air is required.

The requirement signal can be, for example, merely an indicating signal, and/or can be used for the further development of indicating signals for the driver, so that the driver receives the request if applicable to change the gear selection and, for example, to select a lower gear and/or a lower transmission ratio, so that the engine control device correspondingly increases the engine rotational speed and consequently the delivery rate of the compressor. This embodiment is particularly possible in the case of a manually-shifted transmission.

A preferred embodiment is, however, possible in the case of an automatic transmission and/or automatic transmission controller, since in this case the compressed-air control device can transmit the requirement signals to the transmission controller and/or to the control device for the transmission unit comprising the drive system and if applicable the coupling.

Consequently, the transmission controller can, for example, in the case of a greater compressed air requirement set a possible lower gear and/or lower transmission ratio, so that the engine control device in turn increases the engine rotational speed and consequently the delivery rate of the compressor is increased.

In accordance with the invention, further and/or alternative embodiments are also possible. In particular, the gear selection can be more complex; so that in accordance with one embodiment of the invention merely one gear selection can be requested that renders possible a higher compressor delivery rate in the case of identical or nearly identical energy utilization; consequently, the transmission ratio can be reduced if no additional costs arise as a consequence. In this case, it is possible to utilize characteristic curve ranges of the energy utilization, in which there is no difference and/or substantially no difference in energy utilization between different gears and corresponding engine rotational speeds; in these cases it is possible, for example, by setting a lower gear and consequently a higher engine rotational speed to achieve a higher compressor delivery rate without increasing additional consumption in the driving mode.

This facility can also be extended in accordance with the invention to the extent that even in the case of a less efficient energy utilization it is possible to knowingly increase the compressor delivery rate; consequently, for example, the gear and/or transmission ratio can be controlled in the downwards direction even if, as a consequence, additional costs arise.

The assessment, as to whether, for example, despite a higher energy consumption, a gear change is to be performed, can be made, for example, in dependence upon priority information in the requirement signal, if applicable, whilst assessing the additional energy costs.

The evaluations or assessments can be performed directly in the transmission controller and/or the control device of the transmission unit; the logic required for this purpose can, however, also be divided between the control device of the drive system and the control device of the air processing system. In accordance with the invention, combined and/or integrated embodiments of the compressed-air control device and the control device of the drive system are in particular also possible, possibly also whilst including the functionalities of the engine control that take into consideration these more complex assessments.

In addition, particularly when used in a hybrid vehicle, it is also possible to take into consideration different operating modes of a hybrid vehicle, in particular of a parallel-hybrid vehicle, where, for example, a recuperating mode or a purely electric drive is possible. In accordance with the invention, it is possible in particular to change the coupled-in or decoupled state of the combustion engine by means of the requirement signal.

Consequently, in addition to the request for or change of a gear selection, in particular for a hybrid vehicle, the following, additional facilities are available for interventions in response to the requirement signal:
A decoupling of the combustion engine from the output train during coasting phases can be allowed if there is no greater compressed air requirement. Consequently, the kinetic energy prevailing in the coasting phase can be fully utilized at the electric generator or fully utilized for a coasting mode of the vehicle without engine braking the combustion engine.
A decoupling during coasting phases can be prevented or can be signaled as being undesired, i.e. the combustion engine is fixedly coupled to the output train. Consequently, the compressor is simultaneously actuated by way of the engine shaft, so that it is also possible during the coasting phase to recover kinetic energy by delivering compressed air and, if applicable, the amount of energy recovered by the electro-motor and/or the generator during the recuperating mode is at least limited.
In addition, the coupling-in can be requested during the coasting phase if air is to be delivered again.

The inventive embodiments render possible a plurality of advantages. For instance, it is possible to save fuel by delivering compressed air when the vehicle is traveling. In particular, it is possible not only to change the engine rotational speed when the engine is idling but also to change the gear selection when the vehicle is traveling. In this case, it is possible to utilize characteristic curve regions of the energy generation and engine capacity utilization in order to deliver compressed air with or without a comparatively small additional consumption.

A further advantage is a rapid reaction to the air requirement when the vehicle is traveling. In the event that, when the vehicle is traveling and consequently when the combustion engine is coupled-in, there is a greater air requirement, the engine rotational speed can also be influenced in the desired manner by changing the transmission setting in order to change the quantity of air being delivered, in particular to increase the quantity of air being delivered.

A further advantage resides in the increased amount of recovered electrical energy when used in a hybrid vehicle by decoupling the combustion engine during coasting phases if the air processing system requires an additional amount of compressed air.

Consequently, it is possible during normal operation to save fuel and consequently also to reduce the CO₂ emissions. In addition, the air reservoir to be used in the vehicle can be reduced in size and/or the compressor delivery rate can be reduced, since the return feed in accordance with the invention can be quicker.

The invention is explained in detail hereinafter with reference to exemplary embodiments and the attached drawings, in which:

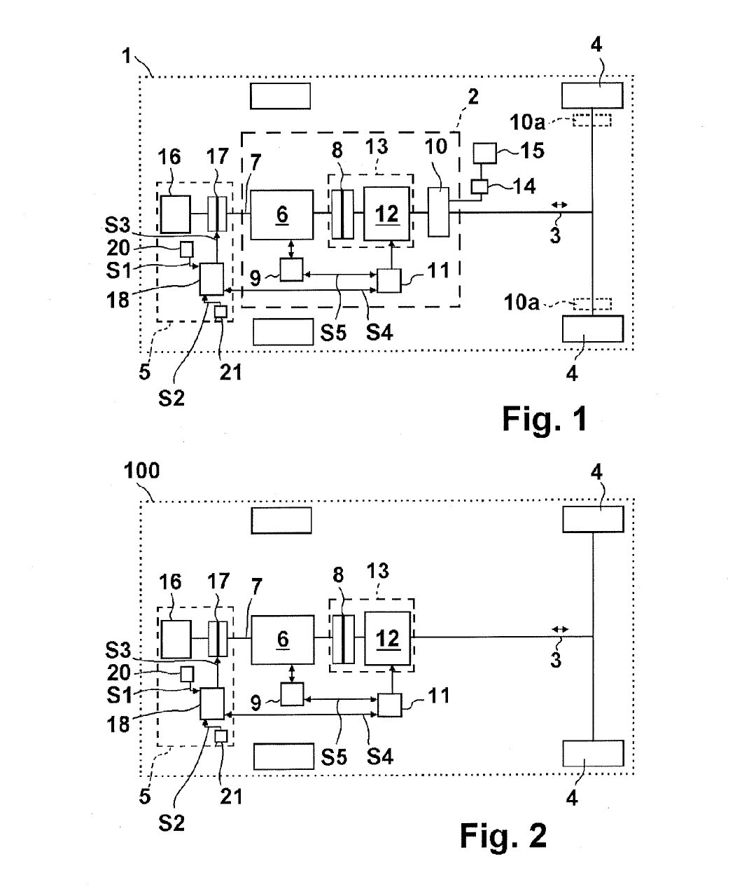

FIG. 1 shows a utility vehicle with its essential assemblies in accordance with a first embodiment having a hybrid drive and an automatic transmission controller;

FIG. 2 shows a utility vehicle in accordance with a second embodiment having a combustion engine and an automatic transmission controller; and

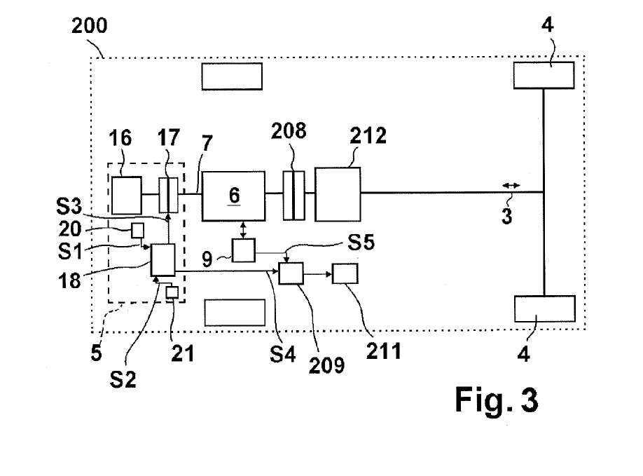

FIG. 3 shows a utility vehicle in accordance with a third embodiment having a combustion engine and a manually-shifted transmission.

FIG. 1 illustrates a hybrid utility vehicle 1 that comprises a hybrid assembly 2 and an output shaft 3 that leads to driven wheels 4. In addition, a compressed air system 5 is provided that is provided in particular to supply pneumatic brakes, preferably also to provide a level control and, if applicable, for additional compressed air consumers.

The hybrid assembly 2 comprises a combustion engine 6, a coupling-transmission unit 13 and an electric motor 10, from which the output shaft 3 issues. The coupling-transmission unit 13 comprises a coupling 8 and a drive system 12 and is controlled by an automatic transmission controller 11. In this case, the hybrid assembly 2 represents a parallel-hybrid, since the combustion engine 6 can be decoupled from the remaining drive train by way of the coupling-transmission unit 13 and consequently in the case of an open coupling 8 or when the drive system 12 is in the idling setting only the electro-motor 10 is coupled to the output shaft 3, so that an electric drive mode is possible merely by way of the electro-motor 10 and, in addition, a recuperating mode and/or utilizing mode is possible during a coasting phase, in which the electro-motor 10 functions as a generator and charges a vehicle battery (accumulator) 15 by way of an electronic convertor unit 14.

In addition, as is known per se, a purely conventional drive by way of the combustion engine 6 in the case of a switched-off and/or non-activated electro-motor 10 and coupled-in coupling 8 and a parallel operation are possible by means of both the combustion engine 6 and also the electro-motor 10.

In FIG. 1, the broken lines indicate hub electro-motors 10a that can be provided as an alternative or also in addition to the electro-motor 10. In the event that hub electro-motors 10a of this type are provided, the block 10 can represent a pure generator in order to render possible or completely omit a recuperating mode, if the hub electro-motors can be used as generators.

A compressor 16 is either fixedly connected to an engine shaft 7 of the combustion engine 6 or connected to the shaft by way of a compressor coupling 17. In the case of an embodiment without a compressor coupling 17, the compressor 16 likewise runs simultaneously in the idling mode if there is no compressed air requirement; in the case of the illustrated embodiment, the compressor 16 can be decoupled by way of the compressor coupling 17. In addition to the compressor 16, the compressed air system 5 comprises a compressed-air control device 18 and components that are not illustrated, such as air driers and corresponding electro-pneumatic valve arrangements in order to set different operating modes of the compressed air system 5. In addition, the compressed air system 5 can comprise a moisture sensor 20 that is provided, for example, at the output of an air dryer, and comprises pressure sensors 21 that are provided, for example, in the operating brake circuits of the compressed air system 5. Also, compressed air consumers that are not illustrated such as the air spring system or brakes can indicate by way of signals to the control device 18 an increased compressed air requirement. The control device 18 receives measurement signals S1, S2 from the sensors 20, 21 in order, on the basis of these measurement signals S1, S2 and additional stored parameters, to determine the compressed air requirement and the initiation of the different operating phases of the compressed air system 5. In order to initiate the different operating modes that can comprise, in particular, a delivery phase, a regeneration phase and an idling phase, the compressed-air control device 18 initially transmits a switching signal S3 to the compressor coupling 17 or to a compressor-idling switch and switching signals that are not further illustrated to the valve arrangement of the compressed air system 5.

In addition, the compressed-air control system 18 transmits a requirement signal S4 to the transmission controller 11 (transmission control). The transmission controller 11 sets the different gears and/or transmission ratios of the drive system 11. For this purpose, the transmission controller 12 receives in a manner known per se bi-directional signals S5 from an engine control device 9. In addition, the transmission controller 11 can actuate the coupling 8. The coupling 8 can be integrated in the drive system 12.

In accordance with the present invention, it is provided that the compressed-air control device 18 transmits requirement signals S4 to the transmission controller 11 in order to indicate a requirement and/or a demand for the transmission setting to be changed. The requirement signals S4 are generally a demand. In accordance with different embodiments of the invention, they can be in the form of a request or a command. Consequently, it is possible in accordance with a first embodiment that the requirement signals S4 have the highest priority and immediately result in a corresponding change of the transmission setting, i.e., in particular to the setting of a different gear. In accordance with an alternative embodiment, the requirement signals S4 have a lower priority, in particular with respect to the demands and/or to the further requirement signals S5 from the engine control device 9, so that initially an optimum driving mode is ensured. In accordance with a further embodiment, the requirement signals S4 can indicate different priorities, so that they indicate, for example, a lower priority than the requirement signals S5 if there is no increased air requirement, whereas in the case of a high and/or urgent air requirement they indicate a higher priority than S5.

The requirement signals S4 can, in particular, demand the following control procedures that are then to be performed by the transmission controller 11 by way of the control signals S6:

a) Permit decoupling during coasting phases, in particular for a purely electric drive or a recuperating mode, so that all the kinetic energy is available during the coasting phase at the electric generator and/or at the electro-motor 10 that functions in the generator mode. In the case of a comparatively small compressed air requirement or no compressed air requirement, the hybrid drive can consequently function freely and demonstrate its advantages, in particular perform these two additional types of operation.

b) Prevent decoupling during coasting phases. The combustion engine 6 always rotates simultaneously by way of the engine shaft 17 and as a consequence the compressor 16 is supplied with kinetic energy. Consequently, energy from the coasting energy is recovered not merely by means of the generator and/or the electro-motor 10 that functions in the generator mode; on the contrary, the coasting energy is also available to the combustion engine 6 that drives the compressor 16 by way of the engine shaft 7. Consequently, a portion of the coasting energy that is available during a coasting phase can be utilized in order to deliver air.

c) Demand coupling-in during coasting phases. In addition to b), an active coupling-in is also performed in order to increase the delivery rate of the compressor 16.

d) Demand a change of the respective gear or transmission ratio. Consequently, a change can be actively demanded. In particular, a gear selection can be demanded that renders possible a higher delivery rate of the compressor 16.

For this purpose, a lower gear is demanded so that as a consequence thereof, the engine control 9 increases the engine rotational speed of the combustion engine 6. As a result, the compressor is also supplied with more kinetic energy. This can occur, for example, by demanding a specific gear, by means of a general demand to increase the rotational speed or by means of the demand for a desired rotational speed or a desired rotational speed range. Since the compressor 16 is arranged directly on the engine shaft 7, the performance can be changed directly by means of changing the transmission setting according to the engine rotational speed of the combustion engine 6. By virtue of the fact that the transmission ratio is reduced and/or the gear selection lowered (for example, from fourth gear to third gear) the rotational speed of the combustion engine 6 is correspondingly increased by the engine control device 9, so that a higher rotational speed is also available for the compressor 16 by way of the engine shaft 7.

In an advantageous manner, the gear and/or the transmission setting can be changed in this manner if there is no difference in the energy utilization or if there is at the most a comparatively small difference in the energy utilization between the different gears, as is the case according to the characteristic curves in the case of some engine and transmission layouts.

In addition, it is also possible to change the gear selection in order also to render possible a higher compressor delivery rate even in the case of a less efficient energy utilization; consequently, for example, a lower gear is selected, even if it means a higher consumption, since there is a requirement for more air.

In accordance with the invention, the compressed-air control device 18 of the compressed air system 5 can in each case transmit the requirement signals S4 with a demand indication and/or a priority, wherein further consideration is given by means of the transmission controller 11. The transmission controller 11 can in this case respond to this requirement indication in a manner that is coordinated with and dependent upon the driving situation and optimizes consumption, in particular whilst taking into consideration the additional requirement signals S5 from the engine control device and additional data regarding the vehicle status. For this purpose, data such as the engine rotational speed etc. that is available particularly on the CAN bus or other bus systems can be processed and in response thereto a gear and/or idling mode can be selected in each case by way of the control signals S6.

This evaluation and/or the logic for the consideration and the priority of the requirement signals S4 can be the sole responsibility of the transmission controller 11 or it can be divided between the compressed-air control device 18 and the transmission controller 11. Consequently, the engine rotational speed is fundamentally also taken into consideration in the compressed-air control device 18.

In accordance with an embodiment of the invention, the compressed-air control device 18 and the transmission controller 11 can also be combined in a common control device and/or ECU; they can, however, also be divided between two to four control devices, such as the compressed-air control device 18, the transmission controller 11, the control device of the coupling and, if applicable, an additional control device for a coordinating logic. It is also possible, particularly in the case of hybrid vehicles, to include the engine control device for combustion engines and electro-motors in the controller in order to ensure that all systems are coordinated. As a consequence, it is possible, for example, to avoid that during a purely electric-drive mode the combustion engine is switched off or will be switched off if the compressed-air control device has recognized a requirement for compressed air.

The requirement signal S4 can be transmitted in particular by way of a vehicle-internal network protocol, for example the CAN bus or also the LIN bus or a FlexRay bus, but also by way of dedicated electrical lines. When utilizing the CAN bus, standardized SAE J1939 messages or optimized proprietary message formats can be utilized.

The transmission controller 11 can transmit a feedback signal to the compressed-air control device 18, for example by way of a bus protocol or the dedicated lines.

The embodiment of FIG. 2 illustrates a utility vehicle 100 having a conventional drive, i.e., only a combustion engine 6 that drives the output shaft 3 by way of the coupling 8 and the drive system 12. In the case of this embodiment, the identical functionality to that of FIG. 1 is fundamentally possible; however, in the respective logic it is not to be taken into consideration that during a coasting phase a recuperating mode is possible whilst utilizing the kinetic energy in order to recover electrical energy. Consequently, the requirement signals S4 can be weighted, for example, with a high priority and as soon as a comparatively small requirement is indicated, the coupling-in of the coupling 8 during the coasting mode can be demanded in order to utilize the kinetic energy in order to operate the compressor 16.

FIG. 3 illustrates an embodiment of a utility vehicle 200 having a combustion engine 6 and a manually-shifted transmission 212 and a coupling 208. In the case of this embodiment, it is consequently not possible to perform automatic changes to the transmission setting in response to the requirement signals S4, as is possible in FIGS. 1 and 2. The compressed-air control device 18 can, however, transmit the requirement signals S4 directly or indirectly to a display device 211 that indicates to the driver in the driver's cabin advantageous changes to the transmission setting and/or the gear selection, i.e., for example by using an arrow to indicate the demand to change down a gear or to change up a gear. This display device 211 can be provided in particular with a control device 209 that likewise receives from the engine control device 9 the requirement signals S4 and if applicable also corresponding indicating signals S5, so that in this case the weighting can be applied in the control device 209.

1. A vehicle (1, 100, 200) that comprises:
a combustion engine (6),
an output shaft (3),
a transmission unit (13, 8, 12, 212, 208) that is provided between the combustion engine (6) and the output shaft (3) in order to set different transmission ratios and/or decouple the combustion engine (6) from the output shaft (3), and
a compressed air system (5) having a compressor (16) that is arranged on an engine shaft (7) of the combustion engine (6) and having a compressed-air control device (18),
characterized in that
the compressed-air control device (18) transmits a requirement signal (S4) for a transmission setting.

2. The vehicle (1, 100) as claimed in claim 1, characterized in that it comprises an automatic transmission controller (11) in order to set an automatic transmission (12) and/or an automatic coupling (8) in order to couple-in and decouple the combustion engine (6) and the compressed-air control device (18) transmits the requirement signal (S4) directly or indirectly to the automatic transmission controller (11).

3. The vehicle (1, 100) as claimed in claim 2, characterized in that the requirement signal (S4) comprises a priority signal, for example with a higher priority than the command signal or a lower priority than the demand signal or desired signal in order to be taken into consideration in a preferential manner or with a lower priority.

4. The vehicle (1, 100) as claimed in claim 2 or 3, characterized in that the transmission controller (11) or an upstream logic device receives both the requirement signal (S4) from the compressed-air control device (18) and also a second requirement signal (S5) from an engine control device (9) of the combustion engine (6) and in response thereto forms control signals (S6) in order to set the transmission unit (12, 9).

5. The vehicle (1) as claimed in any one of claims 2 to 4, characterized in that it is a hybrid vehicle (1) having a hybrid assembly (2),
wherein the hybrid assembly (2) comprises the combustion engine (6) and at least one electro-motor (10, 10a), and
wherein the hybrid vehicle (1) can be operated inter alia in a recuperating mode whilst recovering kinetic energy for conversion into electric energy.

6. The vehicle (1, 100) as claimed in any one of claims 2 to 5, characterized in that in response to the requirement signals (S4) one or a plurality of the following transmission settings can be performed:
a) Permit decoupling during coasting phases, in particular for a purely electric drive or a recuperating mode;
b) Prevent decoupling during coasting phases in order to increase the delivery rate of the compressor (16),
c) Demand coupling-in during coasting phases in order to increase the rotational speed and as a consequence increase the delivery rate of the compressor (16),
d) Demand a setting or change of gear or transmission ratio.

7. The vehicle (1, 100) as claimed in claim 6, characterized in that in step d) the compressed-air control device (18) upon establishing a compressed air requirement in a requirement signal (S4) demands that a lower gear with a lower transmission ratio be set in order to increase the engine rotational speed with a corresponding increase in the delivery rate of the compressor (16).

8. The vehicle (1, 100) as claimed in claim 6 or 7, characterized in that in step d) the gear or transmission ratio is set or changed in dependence upon energy utilization as a function of the transmission setting and engine capacity utilization.

9. The vehicle (1, 100) as claimed in any one of claims 2 to 8, characterized in that the compressed-air control device (18) and the transmission controller (11) are integrated in a common control device.

10. The vehicle (200) as claimed in claim 1, characterized in that the requirement signal (S4) is an indicating signal, which the compressed-air control device (18) transmits to a display device (211) in order to indicate a gear change demand to the driver and/or to a control device (209) of the indicating device (211).

11. A method for controlling an automatic drive system (12) of a vehicle (1, 100) that comprises a compressed-air system (5) having a compressor (16) that is arranged on an engine shaft (7) of a combustion engine (6), in which a compressed-air control device (18) determines a compressed air requirement of the compressed air system (5) and in response thereto transmits requirement signals (S4).
